(19) United States
(12) Patent Application Publication
(10) Pub. No.: US 2022/0238942 A1
(43) Pub. Date: Jul. 28, 2022

(54) Hydrogel-Based Rechargeable Battery

(71) Applicant: Queen's University at Kingston, Kingston (CA)

(72) Inventors: Sreemannarayana Mypati, Kingston (CA); Ali Khazaeli, Kanata (CA); Dominik Barz, Kingston (CA)

(21) Appl. No.: 17/580,955

(22) Filed: Jan. 21, 2022

Related U.S. Application Data
(60) Provisional application No. 63/141,197, filed on Jan. 25, 2021.

(51) Int. Cl. H01M 12/08; H01M 4/134

(52) U.S. Cl. CPC H01M 12/08; H01M 4/134

(57) ABSTRACT

A hydrogel battery includes a first compartment comprising a first electrode metal and a first hydrogel and a second compartment comprising a second electrode metal and a second hydrogel, and a background electrolyte (BGE) metal ion species. At least one of the first and second hydrogels selectively coordinates ions of the respective first and second electrode metals. The first hydrogel and the second hydrogel allow the BGE metal ion species to travel between the first and second compartments. A hydrogel battery may be implemented without a separator disposed between the first and second compartments, and may be rechargeable and/or flexible.

### RELATED APPLICATION

This application claims the benefit of the filing date of Application No. 63/141,197 filed Jan. 25, 2021, the contents of which are incorporated herein by reference in their entirety.

### FIELD

This invention relates to rechargeable batteries. More particularly, the invention relates to rechargeable batteries using hydrogels as electrolytes and to hydrogel batteries that avoid the need for a separator between electrode compartments (half-cells).

### BACKGROUND

There is increasing demand for battery-powered portable and mobile technologies in a wide variety of fields, such as point of care testing diagnostics, personal devices including wearable electronics, low- and zero-emission electric vehicles, and smart displays. Among the many rechargeable battery technologies, the development of non-lithium ion based secondary batteries is of interest due to their low cost and abundance of raw materials in the environment. For example, among other attractive battery chemistries, zinc (Zn) based electrodes have many advantages such as high specific (theoretical) capacity of 820 mAh g⁻¹, as well as balanced kinetics, stability and reversibility in aqueous solutions, low electrochemical potential (−0.763 V versus the standard hydrogen electrode) and two-electron transfer during redox reaction leading to a high energy density; high natural abundance of raw materials and suitability for mass production; and low toxicity and intrinsic safety owing to their aqueous nature. However, the zinc electrode must be combined with another electrode material to function as a battery.

Conventionally, zinc-based batteries are utilized in conjunction with alkaline electrolytes, such as Zn-Manganese(IV) oxide (MnO₂), Zn-Nickel oxide hydroxide (NiOOH), and Zn-air. Such batteries exhibit irreversible discharge products or limited cycling performance (Parker et al., 2016; Clark et al., 2019; Zhang et al. 2017). Owing to this, these batteries are generally manufactured as primary batteries. However, technological advancements such as nano-scopic materials have made zinc-based batteries rechargeable by using alternative electrolytes and electrode morphologies. For instance, Pan et al. (2016) demonstrated a rechargeable Zn—MnO₂ battery in an acidic electrolyte. The cathode was prepared with α-MnO₂ nanofibres and a capacity of around 260 mAh g_{MnO}_{₂}⁻¹ at 1.8 mA cm⁻² was achieved. Parker et al. (2016, 2017) investigated a rechargeable alkaline Zn—NiOOH battery by modifying the Zn anode morphology (3D zinc sponge) and the electrolyte composition using lithium hydroxide, potassium silicate, potassium fluoride, potassium carbonate, calcium hydroxide and/or combinations as additives, a capacity of 164 mAh g_{Zn}⁻¹ at a current density of 5 mA cm⁻¹ was obtained. Nevertheless, despite adopting several strategies for performance enhancement of aqueous Zn-based batteries, no capacities higher than 660 mAh g⁻¹ have been realized so far. In terms of flexible aqueous Zn-based batteries, 360 mAh g⁻¹ has been reported (Liu et al. 2016; Zheng eta;l. 2017; Song et al., 2018; Fang et al., 2018; Selvakumaran et al., 2019).

To make Zn-based batteries a competitor for the commercial Li-ion batteries, the Zn electrode must be combined with electrode materials having a similar high theoretical specific capacity and a two-electron charge transfer mechanism. In this regard, copper is a suitable material due to its high theoretical capacity (844 mAh g⁻¹) and the two-electron transfer mechanism in mildly acidic aqueous solution (Zhu et al., 2019); it is also abundant, infinitely recyclable, and thus environmentally benign.

The Zn—Cu battery (Daniell cell) is one of the earliest non-rechargeable batteries. The original Daniell cell was introduced 1836 and consisted of a Zn electrode immersed in sulfuric acid (H₂SO₄) while a copper cathode was in contact with concentrated copper sulphate (CuSO₄). Later the H₂SO₄ electrolyte was replaced with either zinc sulphate (ZnSO₄) or sodium chloride (Boulabiar et al., 2004). In neutral and acidic electrolytes, the Zn and Cu electrode reactions are simple redox reactions of the form Me^{+z}+z e⁻⇄Me. A concentration gradient must be maintained to prevent the exchange of ionic species between the different electrolytes, and the electrolytes are separated by a barrier or separator. Historically, porous barriers such as unglazed earthenware were used. Likewise, salt-bridges with sodium sulfate Na₂SO₄ or potassium nitrate were used. However, these barriers are not selective with respect to the permeability of (molecular) species and over time copper ions (Cu²⁺) migrate towards the Zn electrode, which results in performance loss and self-discharge of the battery even at open circuit conditions (Dong et al., 2014; Parikipandla et al., 2017). These problems are accelerated when the battery is recharged since the induced electric field in the electrolyte enhances the crossover of Cu²⁺.

There are different strategies used to implement the separator. An anion selective separator prevents the crossover of cations, which can make a Zn—Cu battery rechargeable. However, owing to the generally poor ionic conductivity (≤5 mS cm⁻¹) of anion selective separators, selective cation exchange membranes (CEMs) are preferred for use in batteries (Chen et al., 2013; Lim et al., 1977). CEMs are made form a polymeric backbone containing functional groups. Examples are Teflon-based Nafion® 125 and polypropylene-based Celgard® 3400 that were used in Zn-bromide batteries, which share a similar problem of ion crossover as Zn—Cu batteries (Lim et al., 1977). In this case, the electrolytes contained additives, such as potassium chloride and sodium chloride. These background electrolytes (BGE) were added for two reasons: (i) to increase the conductivity of the electrolyte and therefore to lower the ohmic losses of the battery; and (ii) as a charge shuttle that does not participate in the redox reactions but is exchanged across the separator to maintain electroneutrality despite the consumption or production of (ionic) reactants.

The combination of ion exchange membrane and non-reactive charge shuttle was applied to make a rechargeable Zn—Cu battery. Dong et al. (2014) used a Li-based BGE and a ceramic separator LATSP (Li_{1+x+y}AlₓTi₂₋ₓSi_{y}P_{3-y}O₂) film which allows for the exchange of Li ions but not Cu²⁺. This battery achieved a specific capacity of 843 mAh g_{Cu}⁻¹ at a very low current density of 0.1 mA cm⁻². Zhang et al. (2015) used a Li-selective separator along with a lithium sulfate BGE which achieved a specific capacity of 330 mAh g_{Cu}⁻¹ at a current density of 1 mA cm⁻². However, these separators are complex composite material and lithium is a relatively expensive material. Recent research demonstrated that the cost-effective commercial Neosepta™ CIMS monovalent cation exchange membrane along with an inexpensive Na₂SO₄ BGE can be used to create a rechargeable Zn—Cu battery (Jameson et al., 2020). The capacity of this cell was 583 mAh g_{Cu}⁻¹ at 1 mA cm⁻².

### SUMMARY

According to one aspect of the invention there is provided a hydrogel battery, comprising: a first compartment comprising a first electrode metal and a first hydrogel; a second compartment comprising a second electrode metal and a second hydrogel; a background electrolyte (BGE) metal ion species; wherein at least one of the first hydrogel and the second hydrogel selectively coordinates ions of at least one of the first and second electrode metals; wherein the first hydrogel and the second hydrogel allow the BGE metal ion species to travel between the first and second compartments.

In one embodiment, only the first hydrogel selectively coordinates metal ions.

In one embodiment, the first electrode metal that is coordinated in the first hydrogel is selected from copper, cadmium, chromium, iron, manganese, nickel, zinc, cerium, and silver.

In one embodiment, the second electrode metal that is coordinated in the second hydrogel is different from the first electrode metal and is selected from copper, cadmium, chromium, iron, manganese, nickel, zinc, cerium, and silver.

In one embodiment, the second electrode metal that is not coordinated in the second hydrogel is different from the first electrode metal and is selected from copper, cadmium, chromium, iron, manganese, nickel, zinc, cerium, silver, lead, and cobalt.

In one embodiment, the first electrode metal comprises copper and the second electrode metal comprises zinc.

In one embodiment, the BGE metal ion species is at least one of sodium (Na⁺) and potassium (K⁺).

In one embodiment, the BGE metal ion species is sodium (Na⁺).

In one embodiment, the first compartment and the second compartment are in contact with each other without a separator disposed between them.

In one embodiment, the hydrogel battery is rechargeable.

In one embodiment, the hydrogel battery is flexible.

According to another aspect of the invention there is provided a method for preparing a hydrogel battery, comprising: providing a first compartment comprising a first electrode metal and a first hydrogel; providing a second compartment comprising a second electrode metal and a second hydrogel; providing a background electrolyte (BGE) metal ion species; wherein at least one of the first hydrogel and the second hydrogel selectively coordinates ions of at least one of the first and second electrode metals; wherein the first hydrogel and the second hydrogel allow the BGE metal ion species to travel between the first and second compartments.

In one embodiment of the method, only the first hydrogel selectively coordinates metal ions.

In one embodiment of the method, the first electrode metal that is coordinated in the first hydrogel is selected from copper, cadmium, chromium, iron, manganese, nickel, zinc, cerium, and silver.

In one embodiment of the method, the second electrode metal that is coordinated in the second hydrogel is different from the first electrode metal and is selected from copper, cadmium, chromium, iron, manganese, nickel, zinc, cerium, and silver.

In one embodiment of the method, the second electrode metal that is not coordinated in the second hydrogel is different from the first electrode metal and is selected from copper, cadmium, chromium, iron, manganese, nickel, zinc, cerium, silver, lead, and cobalt.

In one embodiment of the method, the first electrode metal comprises copper and the second electrode metal comprises zinc.

In one embodiment of the method, the BGE metal ion species is at least one of sodium (Na⁺) and potassium (K⁺).

In one embodiment of the method, the BGE metal ion species is sodium (Na⁺).

In one embodiment of the method, the first compartment and the second compartment are in contact with each other without a separator disposed between them.

In one embodiment of the method, the hydrogel battery is rechargeable.

In one embodiment of the method, the hydrogel battery is flexible.

### BRIEF DESCRIPTION OF THE DRAWINGS

For a greater understanding of the invention, and to show more clearly how it may be carried into effect, embodiments will be described, by way of example, with reference to the accompanying drawings, wherein:

FIGS. 1A and 1B are diagrams showing preparation of a zinc compartment hydrogel and a copper compartment hydrogel, respectively, according to embodiments of the invention.

FIGS. 2A and 2B are diagrams showing battery designs and respective charge transfer mechanisms for two Zn—Cu hydrogel batteries: Design I with a separator hydrogel and Design II without a separator, respectively, according to embodiments.

FIGS. 2C and 2D are plots showing results of electrochemical impedance spectroscopy measurements of charged and discharged Zn—Cu hydrogel batteries based on the embodiments of Design I and Design II, respectively.

FIGS. 3A and 3B are cyclic voltammograms of a zinc electrode in contact with a zinc hydrogel at A) various scan rates from 5 mV s⁻¹ to 20 mV s⁻¹ and B) a constant scan rate of 20 mV 5⁻¹ over 50 cycles, according to embodiments.

FIGS. 3C and 3D are cyclic voltammograms of a copper electrode in contact with a copper hydrogel C) at various scan rates from 5 mV s⁻¹ to 20 mV s⁻¹ and D) at a constant scan rate of 20 mV s⁻¹ up over 50 cycles, according to embodiments; the hydrogel in both cases was subjected to a preliminary Cu absorption step.

FIGS. 4A and 4B are plots showing performance of a Zn—Cu hydrogel battery with separator hydrogel (Design I) according to one embodiment, wherein A) shows galvanostatic discharge profiles at different current densities and B) shows galvanostatic charge-discharge cycling performance at 1 mA cm⁻².

FIGS. 5A-5D are plots showing performance of a separator-less Zn—Cu hydrogel battery (Design II) according to one embodiment, including A) galvanostatic discharge profiles at different current densities; B) galvanostatic charge-discharge cycling performance at 1 mA cm⁻²; C) charge and discharge profiles at selected cycles; and D) results of electrochemical impedance spectroscopy measurements of the battery for the 50^{th,} 75^{th}, and 100^{th} charge-discharge cycle; symbols depict experimental data while lines are only for guidance.

FIGS. 6A-6H are SEM images and corresponding EDX spectra of a separator-less Zn—Cu hydrogel battery according to one embodiment: A, B) zinc electrode after cycling; C, D) zinc hydrogel after cycling; E, F) copper electrode after cycling; and G, H) copper hydrogel after cycling; insets in B, D, F, and H are respective optical images.

### DETAILED DESCRIPTION OF EMBODIMENTS

Described herein are rechargeable batteries comprising hydrogel-based electrolytes that do not require a barrier or separator (referred to as “separator” hereinafter). The need for a separator, regardless of its composition or structure, is avoided by the use of hydrogels that are designed to coordinate (i.e., lower the mobility of) selected metal ion species in the gel matrix while allowing other metal ion species to move freely within the hydrogels. In lacking a separator, batteries described herein may be considered to comprise “electrode compartments” or simply “compartments”; that is, a metal electrode in contact with a respective hydrogel, wherein a battery includes at least two electrode compartments. The hydrogels of the two electrode compartments are different. Embodiments may be based on a first hydrogel of a first compartment that coordinates one or more selected metal ion species of a first electrode and a second hydrogel of a second compartment that does not coordinate metal ions (i.e., a non-coordinating hydrogel). The first and second hydrogels allow one or more other metal ion species to move freely and shuttle charge between the electrode compartments. As an example of such an embodiment, in a Zn—Cu battery, a hydrogel that coordinates Cu²⁺ may be used in one compartment to prevent its crossover to the other compartment having a different hydrogel, while an uncoordinated background electrolyte (BGE) ion such as Na⁺ is exchanged between the compartments to maintain electroneutrality. Alternatively, in other embodiments, such as Zn—Cu and Fe—Cu batteries, a hydrogel that coordinates Zn²⁺ or Fe²⁺ may be used in one compartment to prevent its crossover to the other compartment having a different hydrogel, while an uncoordinated background electrolyte (BGE) ion such as Na⁺ is exchanged between the compartments to maintain electroneutrality.

Other embodiments may be based on a first hydrogel of a first compartment that coordinates one or more selected metal ion species and a second hydrogel of a second compartment that coordinates one or more different selected metal ion species, and the first and second hydrogels allow one or more other metal ion species to move freely and shuttle charge between the electrode compartments.

In accordance with concepts and embodiments described herein, electrode metals that can be coordinated in a gel may include, but are not limited to, e.g., copper, cadmium, chromium, iron, manganese, nickel, zinc, cerium, and silver. In some embodiments, one of these electrode metals may be used in a coordinating hydrogel and another of these electrode metals may be used with a non-coordinating hydrogel. In some embodiments, one of these electrode metals may be used in a first coordinating hydrogel and another of these electrode metals may be used in a second coordinating hydrogel. In addition to these metals, other electrode metals may be used with non-coordinating hydrogels, such as, but not limited to, lead and cobalt. For some metals, such as lead, use may be based on the metal as a salt (e.g., lead sulfate) or other form. As will be apparent to one of ordinary skill in the art, the selection of electrode metals may be based on electrochemical thermodynamics; that is, the differences in potentials of the two electrodes. Since each metal has an individual standard potential for a reduction reaction, two electrode metals with different potentials are selected. For example, the difference in potentials of the metals may be at least about 1 V.

Gels used in accordance with embodiments described herein may exhibit the ability to take up a considerable amount of liquid, and may be referred to as hydrogels. Whereas embodiments are described herein primarily with respect to hydrogels, other types of gels may also be used. Although hydrogels have found limited use in power sources such as in Zn—Ni and Zn—MnO₂ batteries (Lee et al., 2013; Wang et al., 2018), in those batteries they were used solely as thickening agents to prevent free-flow of the electrolyte.

As described herein, gel electrolytes allow for ion transport, provide sufficient mechanical strength to maintain (electronic) separation between the electrodes, and allow flexibility of the battery as may be desired for certain applications, such as wearable devices. A gel electrolyte reduces the risk of electrolyte leakage, resulting in batteries well-suited for one or more of portable, mobile, and wearable device applications. Furthermore, as described herein, gel electrolytes may reduce deterioration (e.g., due to one or more of morphology change and dendrite formation) of the electrodes and ion cross-over after numerous charge-discharge cycles which prevents internal short circuiting and thus provide a robust long-life battery. Additionally, a separator-less battery greatly reduces production cost and complexity of fabrication.

Batteries (and theoretical cell voltages) that can be made according to this disclosure may include copper-based batteries such as Zn—Cu (V=1.1 V) and iron (Fe)—Cu (V=0.8 V). In addition, since other metal ions that can be coordinated in a gel matrix include nickel (Ni), manganese (Mn), lead (Pb), and cobalt (Co), other batteries that can be made may include, but are not limited to, e.g., Mn—Zn (V=1.98 V), Mn—Pb (V=1.1 V), Mn—Ni (V=1.48 V), Mn—Co (V=1.4 V). Batteries using Fe and silver (Ag) may also be made, but are not limited to, e.g., Ag—Fe (V=1.25 V), Ag—Zn (V=1.46 V). Other batteries may be constructed according to embodiments and concepts presented herein and variations thereof by combining such coordinating ions with other electrodes based on, for example, but not limited to, Al, Li, PbSO₄, etc. Embodiments will be further described herein with respect to Zn—Cu batteries.

As noted above, design and functionality of prior Zn—Cu batteries is limited by the necessity of a suitable separator, which considerably increases ohmic losses and does not necessarily impart recharge-ability. Furthermore, although the use liquid (aqueous) electrolytes can provide high ionic conductivity and excellent electrode contact for attaining high capacity, their application in wearable and portable energy storage devices is often limited. Embodiments described herein overcome the drawbacks of prior Zn—Cu batteries by implementing hydrogel-based electrode compartments, wherein at least one electrode compartment includes a coordinating hydrogel.

The contents of all cited publications are incorporated herein by reference in their entirety.

The invention is further described by way of the following non-limiting example.

### WORKING EXAMPLE

Two rechargeable Zn—Cu battery designs, based on configuration of Zn and Cu hydrogels, were made. Performance of the two battery designs was tested and compared. Stability of the hydrogels was tested by conducting cyclic voltammetry of the electrode compartments. Design I had three different hydrogels. Here, an “empty” hydrogel (i.e., without Cu or Zn ions), was sandwiched between the Zn and Cu hydrogels. In this design, the empty hydrogel acts as a separator between the compartments. Design II was a separator-less battery where the Zn and Cu hydrogels were in direct contact with each other.

### 1.1. Materials

Electrodes were made from Zn and Cu foils (Alfa Aesar, Tewksbury, Mass., USA) with respective thicknesses of 0.25 and 0.1 mm. Chemicals used for hydrogel synthesis included copper sulphate pentahydrate (CuSO₄.5H₂O), zinc sulphate heptahydrate (ZnSO₄.7H₂O), sodium sulphate (Na₂SO₄), sodium hydroxide (NaOH), acrylic acid (C₃H₄O₂), N′-methylene-bis(acrylamide) (MBA), potassium persulfate (K₂S₂O₈), disodium ethylenediaminetetraacetic acid (Na₂EDTA.2H₂O), and murexide indicator, which were all of reagent grade (Sigma-Aldrich Canada, Oakville, ON, Canada). Deionized (DI) water (RiOs-DI®3 water purification system, EMD Millipore Corporation, Mass., USA) with a resistivity of 18 MΩ cm was used throughout this work.

### 1.2. Instruments

The pH of the electrolyte solutions and the hydrogels was measured with a digital pH probe (Fisherbrand™ Accumet™ AP125, Ottawa, ON, Canada). Conductivity was determined using a conductivity probe (Sevenmulti™, Mettler Toledo, ON, Canada). A semi-microscale balance (Model CPA225D, Sartorius, Germany) was employed for weight measurements. The electrochemical characterization of the electrodes in contact with the respective hydrogels and the battery was performed with a potentio-/galvanostat (VersaSTAT 3, Princeton Applied Research, Berwyn, Pa., USA). Scanning electron microscopy (SEM) images of gel and electrode surface were taken with a JEOL Model JSM 5800 (JEOL USA Inc., Peabody, Mass., USA). This instrument was also used to perform the energy dispersive X-ray (EDX) spectroscopy measurements of the surface compositions.

### 1.3. Hydrogel Preparation

Synthesis of the hydrogels (electrolyte and separator) requires two methodologies, tailored for each half-cell. In the first method, the aqueous electrolyte is initially prepared, then a gelling agent is added and processed until a gel matrix is formed that encapsulates the liquid electrolyte. In the second method, the gel is first prepared and then the electrolyte is encapsulated due to ion exchange.

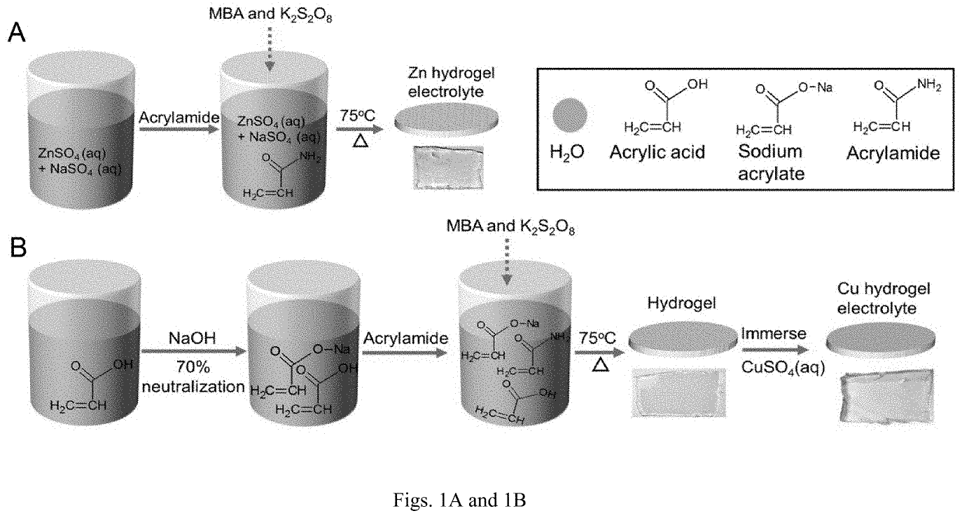

FIG. 1A shows preparation steps of the Zn (i.e., “first”) hydrogel according to the first methodology. In detail, an exemplary Zn hydrogel electrolyte was synthesized by mixing 0.5 M ZnSO₄.7H₂O and 0.5 M Na₂SO₄ and 10 wt % of acrylamide monomer was added, stirred to form a clear solution. Subsequently, 2.5 mg of crosslinker MBA was added while stirring; upon complete dissolution, 0.1 ml of 0.15 M K₂S₂O₈ initiator was added and stirred for another 15 minutes. The solution was transferred to a glass Petri dish and was placed in an oven at 75° C. to allow polymerization and to form the hydrogel. The synthesized hydrogel was then cut into required dimensions to prepare a battery.

The separator hydrogel was prepared by following the same methodology as the Zn hydrogel without the addition of 0.5 M ZnSO₄ in the aqueous solution.

Attempts to make the Cu (i.e., “second”) hydrogel according to the first methodology and conduct a free radical polymerization of acrylamide with an aqueous mixture of CuSO₄ and Na₂SO₄ solutions were unsuccessful due to the retardation effect of Cu²⁺ on the acrylamide polymerization process, as the hydrogel was not formed even after one week. It is believed that this was due to the rupture of the polymer chain in the presence of potassium persulphate initiator. Thus, the Cu hydrogel was prepared according to a second methodology, shown in FIG. 1B, where the Cu²⁺ ions were incorporated in the (pre-formed) hydrogel through absorption by forming chelating complexes with the carboxylic groups in the gel matrix.

FIG. 1B shows preparation steps for making the copolymer of acrylic acid (AA), and acrylamide (AAm) in which the AA is neutralized with NaOH to form sodium acrylate. In detail, an exemplary Cu hydrogel was prepared by cross linked copolymers of AAm and AA by free radical polymerization. A 98% conc. AA (14.27 M) was used, 75% was neutralized with 1 M NaOH to form sodium acrylate. 10 wt % of AAm monomer was added and stirred until it was completely dissolved. Subsequently, 0.25 mg of cross linker MBA was added while stirring. Upon complete dissolution, 0.15 ml of 0.15 M K₂S₂O₈ initiator was added and stirred for 15 minutes. The solution was transferred to a glass Petri dish and spread out into a liquid layer of about 3 mm thickness. The dish was heated at 75° C. for thermal initiation of the polymerization of AAm monomers. The synthesized hydrogel was then cut into required dimensions, and then immersed in 10 ml of 0.05 M CuSO₄.5H₂O aqueous solution for 5 minutes to finalize the Cu hydrogel. Later, the hydrogel was removed from the solution and washed with DI water to remove excess electrolyte.

Electrolyte composition, pH and conductivity of the hydrogels before and after the polymerization are given in Table 1.

TABLE 1
Properties of polymer solutions and hydrogels.

| | | | Conductivity | |
|---|---|---|---|---|
| | Electrolyte composition | State | (mS cm⁻¹) | pH |
| Zinc | ZnSO₄ (0.5M) + Na₂SO₄ | Liquid | 42.5 | 3.28 |
| | (0.5M) | | | |
| | ZnSO₄ (0.5M) + Na₂SO₄ | Liquid | 35.4 | 3.29 |
| | (0.5M) + AAm solution | | | |
| | before polymerization | | | |
| | Zn hydrogel | Gel | 36.7 | 3.41 |
| Copper | AA + AAm solution | Liquid | 34.8 | 4.36 |
| | before polymerization | | | |
| | Hydrogel without Cu⁺² | Gel | 20.9 | 4.86 |
| | ions | | | |
| | Hydrogel with Cu⁺² ions | Gel | 23.8 | 4.81 |

### 1.4. Hydrogel Characterization

The ionic conductivity of the hydrogels was measured using electrochemical impedance spectroscopy (EIS). Here, the hydrogels were sandwiched between two stainless steel (blocking) electrodes. The impedance spectra of the hydrogels allow for extraction of the ohmic resistance of the hydrogel. The specific ionic conductivity was then calculated according to σ=R_{G}l/A, where σ, R_{G}, A and l are the ionic conductivity, ohmic resistance of the hydrogel, and electrode area and distance, respectively. Cyclic voltammetry (CV) at various scan rates was performed to gain insight into the electrochemical reactions, formal reduction potentials, and redox mechanisms. Zn and Cu foils were used as working electrodes in contact with the respective hydrogel, along with a titanium counter electrode, and an Ag/AgCl (3M KCl) reference electrode. Hence, all single electrode potentials are given with respect to this reference electrode.

Additionally, the Cu²⁺ uptake capacity of the Cu hydrogel was measured. The Cu²⁺ were extracted from the hydrogel by immersing it in 2 M H₂SO₄. The solution was subsequently neutralized with 1 M NaOH and then titrated with 0.04 M Na₂EDTA.2H₂O in the presence of murexide indicator for end-point detection. The amount of the encapsulated Cu²⁺ in the hydrogel was then calculated based on the law of mass conservation.

### 1.5. Hydrogel Battery Characterization

The hydrogel batteries were characterized by variety of electrochemical tests. EIS was used with a 5 mV excitation signal over a wide range of frequencies to measure the impedance at open circuit voltage. The potential window for charging and discharging the batteries was experimentally identified with two-electrode CVs. The capacity of the hydrogel batteries was determined with galvanostatic charge-discharge (GCD) cycles. In order to study polarization of the batteries, they were discharged at different current densities. Comparison between the discharge capacity at different current densities gives insight into the capacity fading due to polarization effects. Additionally, the durability of the batteries was investigated by employing EIS before and after a defined number of GCD cycles.

### 2.1. Hydrogel Battery Design

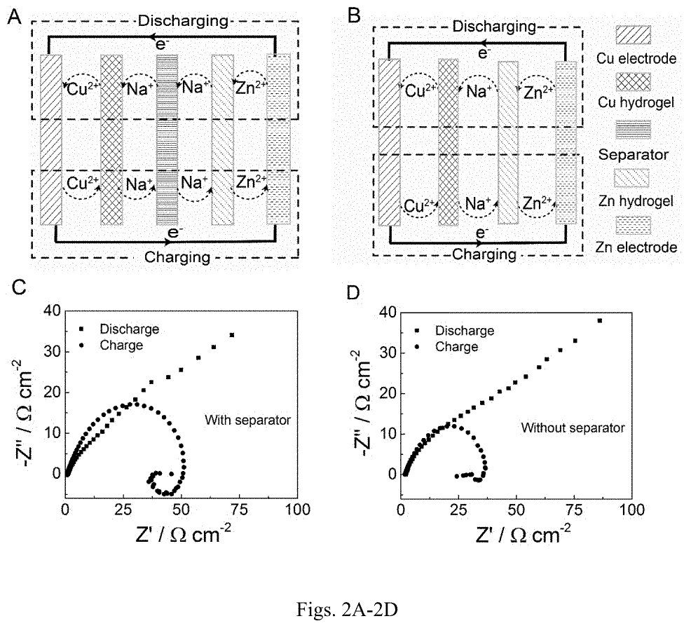

As noted above, in battery Design I an “empty” hydrogel sandwiched between the Zn and Cu hydrogels acted as a separator between the electrode compartments. This hydrogel only contains the non-reactive sodium ions but not the electroactive Zn or Cu ions. Design II was a separator-less battery where the Zn and Cu hydrogels were in direct contact with each other. Both designs utilized Zn and Cu foils as electrodes, which also acted as the current collectors; the respective hydrogels of thickness 1.5 mm were placed directly between the electrodes. All components were closely packed, and the batteries were wrapped with Parafilm® to minimize the cell resistance and moisture loss. The two battery designs are shown schematically in FIGS. 2A and 2B.

In FIG. 2A the ion transport mechanism during the charge and discharge processes are shown for the battery with the separator hydrogel (Design I). The advantages of using this hydrogel as separator are: (i) the Na⁺ ions in the separator balance the charge in the other hydrogels during the charge and discharge cycles; and (ii) it can absorb the Cu²⁺ ions crossing towards the Zn electrode. During the charge process, Cu⁰ at the Cu electrode surface is oxidized to Cu²⁺ which moves into the Cu hydrogel. The Cu²⁺ substitutes two Na⁺ which originate from the sodium acrylate in the hydrogel matrix. The released Na⁺ move into the separator hydrogel where they replace two Na⁺ which move into Zn hydrogel. In the Zn compartment, Zn²⁺ originating from the Zn hydrogel is reduced to Zn⁰ at the Zn electrode surface. This charge imbalance in the Zn hydrogel is compensated by the Na⁺ from the separator hydrogel which form sodium acrylate in the hydrogel matrix. During discharge process, all electrochemical reactions and charge transports are reversed. To summarize, the separator hydrogel transfers Na⁺ to balance charges consumed or produced in the electrode hydrogels. Likewise, to the Cu hydrogel, the separator hydrogel coordinates Cu²⁺ forming an additional barrier against crossover towards the Zn electrode.

FIG. 2B shows the ion transport mechanism during the charge and discharge processes of the battery design without a separator (Design II). During the charge and discharge processes, the charge transfer mechanism between electrodes and respective hydrogels is the same as for design I. The difference is the direct transfer of Na⁺ from Cu hydrogel to Zn hydrogel during charge and vice versa during discharge.

FIG. 2C shows the results of EIS measurements of Design I for fully charged and discharged conditions of an otherwise un-cycled battery. It is observed that the (electrode area-specific) high frequency resistance (HFR) of the fully charged cell corresponds to 2.1 Ωcm⁻². This resistance includes the ohmic resistances of the setup including cables, electrode, and electrolyte resistance. The fully discharged cell had technically the same resistance of resistance of 2.1 Ωcm⁻².

FIG. 2D shows the results of EIS measurements of Design II. The charged battery had a HFR of around 1.3 Ωcm⁻² which was about 30% less than that of Design I. After the first discharge, an HFR of about 2 Ωcm⁻² was measured.

### 2.2. Characterization of the Zinc Electrode Compartment

The ionic conductivity of the hydrogel was measured using EIS. The calculated specific ionic conductivity of the hydrogel was 34.9 mS cm⁻¹. A corresponding liquid electrolyte with the same ion concentration has a conductivity of 42.5 mS cm⁻¹. The diminished conductivity of the hydrogel was expected due to the presence of the gel matrices and the decreased ion diffusivities. The Zn²⁺/Zn redox reaction depends on the acidity of the electrolyte. From a Pourbaix diagram (not shown), it can be determined that this reaction is thermodynamically favorable at pH values of less than 6. At higher pH values, zinc oxide and/or zinc hydroxide are formed that passivate the electrode surface. The pH of the hydrogel was measured to be 3.4, confirming that it provides the right milieu for the desired Zn redox reaction.

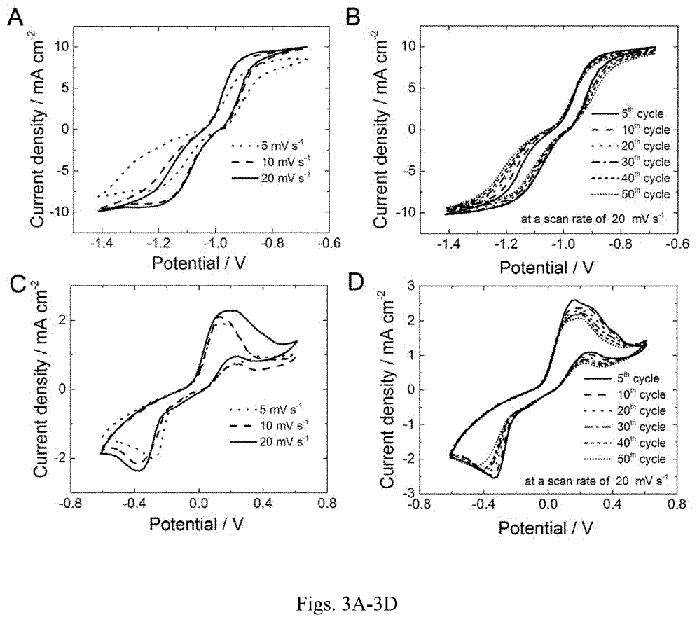

FIG. 3A shows CVs of the Zn electrode in contact with the hydrogel for a potential window of −0.7 V to −1.4 V and at different scan rates, each taken after 10 conditioning cycles. All CVs have the typical form of a bulk electrode with no or only little mass transfer resistances despite that the electrode is in contact with the Zn hydrogel. Likewise, it can be seen that there is little change of the CV with an increase in scan rate. Each single CV features a cathodic and anodic peak at around −1.2 V and −0.91 V, respectively. This gives a formal reduction potential of around -1.05 V which is in close agreement to the aqueous electrolyte at the similar concentrations of Zn₂SO₄ and BGE Na₂SO₄ (Jameson et al., 2020).

FIG. 3B shows the change of the CVs at a scan rate of 20 mV s⁻¹ over 50 cycles. It is observed that there is only a little change in the CV shape and position, which indicates that the system is relatively stable.

### 2.3. Characterization of the Copper Electrode Compartment

The ionic conductivity of the Cu hydrogels (before and after the initial encapsulation with Cu²⁺) was measured using EIS. The ionic conductivity of a hydrogel with and without copper ions was 23.8 mS cm⁻¹ and 18.7 mS cm⁻¹, respectively. The pH of the hydrogels was little influenced by the copper uptake and a pH of about 4.8 was measured in both cases. At this pH, the Cu²⁺/Cu redox reaction occurs without the formation of copper oxides.

FIG. 3C shows CVs of the Cu electrode in contact with the hydrogel in a potential window of −0.6 V to 0.6 V for various scan rates. In general, the CV exhibits a reduction peak at around −0.38 V for the scan rates of 10 mV s⁻¹ and 20 mV s⁻¹, and −0.28 V for the scan rate of 5 mV s⁻¹. A broad anodic peak at positive potentials of about 0.2 V was observed. It appears that each CV contains only a single oxidation and reduction peak. The Cu redox reactions occur in two separate charge transfer reactions, in this case they happen so quickly that they are detected as single peak. The formal reduction potential was determined to be 0.09 V for the higher scan rates and 0.04 V for scan rate of 5 mV s⁻¹.

FIG. 3D shows the change of the CV at a scan rate of 20 mV s⁻¹ over 50 cycles for the Cu electrode in contact with a hydrogel treated with the initial Cu²⁺ encapsulation step. It is observed that the anodic and cathodic peak current decrease with increasing number of cycles. The anodic peak potential almost remained constant at 0.2 V and the cathodic peak shifted towards larger reduction potentials. Comparison with a CV of a Cu electrode in contact with a hydrogel without initial Cu²⁺ encapsulation step (not shown) resulted in inferior performance. Therefore, the initial encapsulation of the hydrogel with Cu²⁺ ions (immersion in aqueous Cu₂SO₄) is beneficial for the performance of the hydrogel battery.

### 2.4. Battery Testing Parameters

The measured open circuit potential of both Zn—Cu battery designs (Design I and II) was about 1 V before charging. To avoid unwanted side reactions and to minimize the hydrogel degradation, a potential window for the GCD should be defined. Accordingly, a CV measurement was conducted in a voltage range of 0.2 V-1.3 V. The CV revealed different redox reactions taking place in this potential window. There is a distinct anodic tail for voltages higher than 1.25 V, which is probably related to the dissociation of water. There is also a minor cathodic tail at voltages lower than approx. 0.2 V, indicating the formation of hydrogen from the protons present in the acidic hydrogel. Hence, a voltage range of 0.3 V to 1.2 V was selected as the charge and discharge cut-off voltage for both the designs.

### 2.5. Electrochemical Performance of Design I

The performance of Design I was evaluated by measuring the voltage vs time profiles at various discharge current densities. The battery was initially charged at a current density of 0.75 mA cm⁻² until the cell voltage reached 1.2 V. Then, the cell was operated at zero current for 120 s to stabilize the potential, and then discharged until the voltage reached 0.3 V. The discharge time and current were used to compute the cell capacity for these discharge conditions. Since the cell capacity is limited by the Cu²⁺ concentration, it is reported herein based on the initial Cu content in the hydrogel.

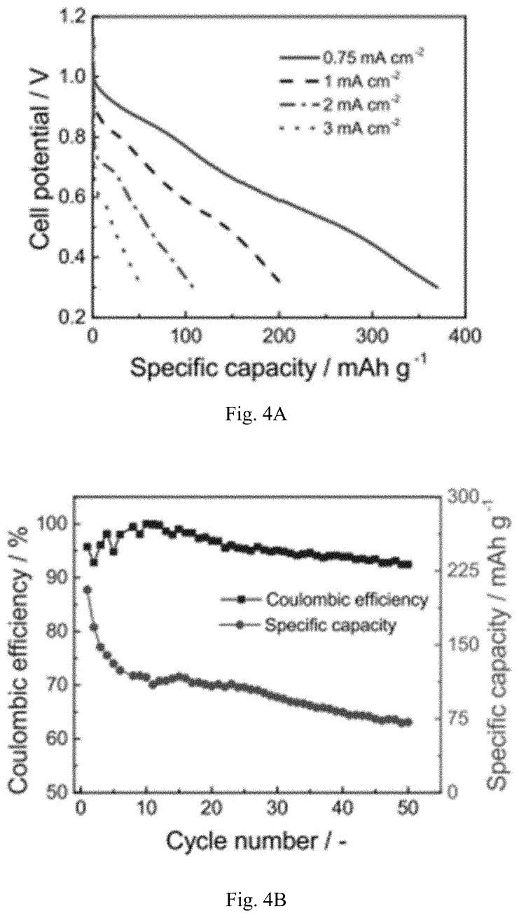

Discharge profiles of the Design I battery were determined at various current densities. All the discharge curves show a similar shape with an open circuit voltage (OCV) of around 1.1 V. At the beginning of the discharge, a voltage drop was observed that increases with increasing current densities. Initially a specific capacity of about 550, 305, 160, and 85 mAh g⁻¹ was measured at current densities of 0.75, 1, 2, and 3 mA cm⁻², respectively. The specific battery capacity was also calculated using a conservative approach based on the limiting content of Cu²⁺ in the hydrogel. This approach used the amount from the absorption step as well as the dissolved amount during the first charge cycle after conditioning (e.g., 10 cycles). The respective amounts were around 15 mg of Cu per g of hydrogel, respectively. According to this approach, the specific capacity was about 370, 205, 108, and 54 mAh g⁻¹ at current densities of 0.75, 1, 2, and 3 mA cm⁻², respectively (FIG. 4A). The GCD cycling performance was determined in terms of specific capacity and columbic efficiency of the battery operated at ±1 mA cm⁻² for 50 cycles. There was a maximum specific capacity of 306 mAh g⁻¹, or 205 mAh g⁻¹ using the conservative approach (FIG. 4B), at the beginning followed by an exponential-like drop for the next 10 cycles. The battery performed with a more or less stable capacity up to another 15 cycles and then decreased linearly with increasing number of cycles. A capacity loss of 65% was observed after a total of 50 cycles. The coulombic efficiency of the battery remained between 92 to 100%, with an initial increase in the first 10 cycles until it reached a maximum efficiency of almost 100% and then decreased to 92% by the end of the experiment. From these results, it can be inferred that both charge and discharge time decreases with the number of cycles.

### 2.6. Electrochemical Performance of Design II

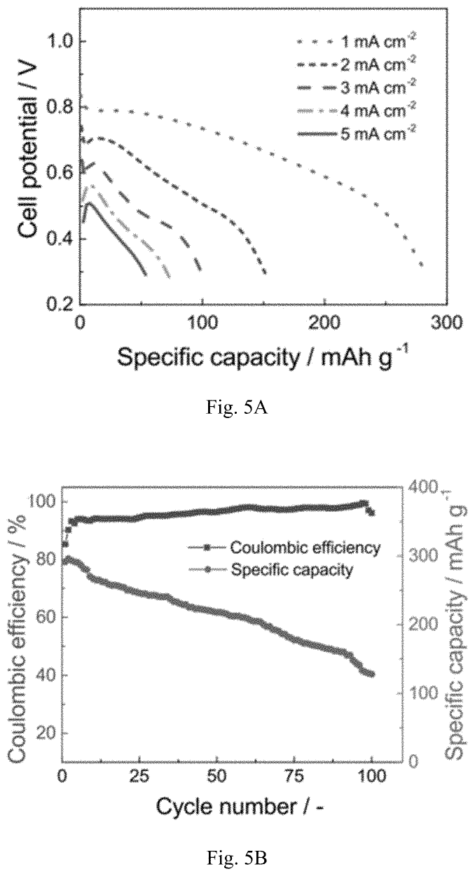

Similar to the Design I, the performance of the Design II was investigated first by measuring the discharge voltage over time at different current densities. Here, the battery was initially charged at a current density of 1 mA cm⁻² until the cell voltage reached 1.2 V and then discharged to 0.3 V. FIG. 5A shows the voltage vs. the specific capacity at discharge current densities ranging from 1 mA cm⁻² to 5 mA cm⁻². All the discharge curves show a similar shape with an initial voltage drop from the OCV of about 1 V. In contrast to the measurements with Design I, a recovery of voltage at the beginning of the curves was observed. The recovery of voltage might be due to the capacitance build-up at the electrode and gel interface which dissolves over time.

From the discharge profiles a specific capacity was initially determined to be about 470, 320, and 220 mAh g⁻¹ at current densities 1, 2, and 3 mA cm⁻², respectively. Using the above-mentioned conservative approach, specific capacity was determined to be about 280, 150, and 95 mAh g⁻¹ at current densities 1, 2, and 3 mA cm⁻², respectively. From these results, it is evident that the battery performs better at relatively low current densities.

The GCD cycles using a Cu²⁺ encapsulated hydrogel were performed at a constant current density of 1 mA cm⁻². FIG. 5B shows the specific capacity and coulombic efficiency of the battery for 100 GCD cycles at ±1 mA cm⁻². Data corresponding to conditioning, i.e., the first 10 cycles, are not shown. There was a small initial increase of the capacity over the first few cycles attributed to further conditioning, up to maximum capacity of about 300 mAh g⁻¹. Subsequently there was a decrease, which was almost linear with the number of cycles. After 100 GCD cycles the capacity was around 120 mAh g⁻¹, corresponding to 40% of the maximum capacity. The Coulombic efficiency also showed a small increase over the first few cycles which is in line with the capacity. However, beyond that point the efficiency did not drop, and instead increased gradually to about 96% before it dropped somewhat at the end of the 100 GCD cycles. Additionally, FIG. 5C shows the charge and discharge voltage over time at selected GCD cycles. For the cycle numbers ≤10, discharge profiles with a voltage recovery were observed. This coincides with the increase in capacity. However, at higher number of cycles, no voltage recovery was observed, and the cycling time became shorter, indicating a significant loss of capacity. The increase in capacity during the first 10 cycles was presumably due to the further dissolution of copper into the hydrogel during charging until it saturates. This increased the availability of Cu²⁺ ions in the hydrogel electrolyte for discharge. This decrease in capacity at higher cycle number might be attributed to dehydration of the hydrogels due to the loss of water molecules during copper ion saturation in the hydrogel.

To obtain further insights into the degradation of the battery, EIS measurements were conducted at cycle number 1, 50, 75, and 100 cycles. The measurements were performed at OCV with a superimposed 5 mV amplitude and a frequency range of 100 kHz to 10 mHz. FIG. 5D and the inset in the figure show the results of the respective cycles. All spectra share a similar shape except for the measurement at the first cycle. The spectra consist of two overlapping semi-circles and a low frequency inductive loop for the initial cycle. The inductive loop contains a negative imaginary impedance that might correspond to an initial dissolution or corrosion of the Zn electrode. The inductive loop disappeared in the later cycles, indicating that the Zn electrode was stabilized. It was also observed that the ohmic resistance is very low for the first cycle; after 50 cycles the ohmic resistance increased and remained with no change in the subsequent cycles.

### 3. Morphology and Composition of Battery Components After GCD Testing

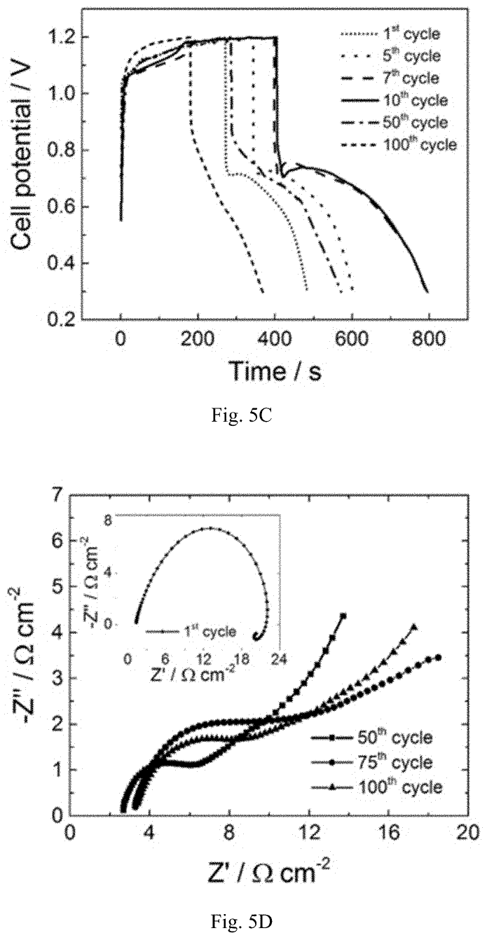

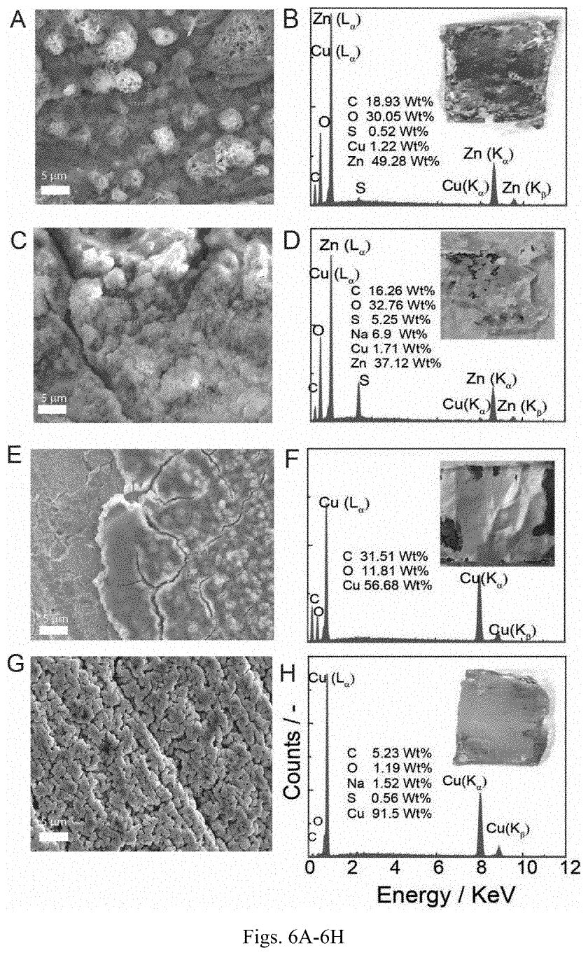

The morphological changes and the composition of the battery (Design II) electrode and hydrogel surfaces after 100 cycles were analyzed based on SEM images and EDX spectra. Design II was studied since there is a greater possibility of Cu²⁺ crossing over to the Zn hydrogel due to the absence of a separator. FIG. 6A shows a SEM image of the Zn electrode after 100 GCD cycles wherein flower-like Zn deposits can be seen on its surface. The EDX spectrum of the Zn electrode is shown in FIG. 6B, which indicates a Cu content of roughly 1%, revealing that there was almost no Cu²⁺ crossover after 100 cycles. FIGS. 6C and 6D show the SEM image and EDX spectrum for the Zn hydrogel surface facing the Zn electrode. Similar to the electrode surface, there are Zn deposits with no sign of dendrite formation. Likewise, there is only negligible Cu content on the hydrogel surface. However, the EDX spectrum indicates a larger quantity of carbon (C) and oxygen (O) both on the electrode surface and the gel due to the presence of gel residual that can also be visualized from the digital images given as inserts in FIG. 6B. FIG. 6E shows a SEM image of the Cu electrode surface where two distinct regions are present. One region is a metallic Cu surface and the other region is a thin layer of residual gel attached to the electrode surface. Measurement of the elemental composition indicated copper (95 wt %) on the metallic surface, whereas the region with gel had only about 57% copper (FIG. 6F). FIGS. 6G and 6H show the SEM image and EDX spectrum of the extracted Cu hydrogel from the battery. From the inset of FIG. 6H, a layer of Cu deposition can be seen on the hydrogel surface and an observed increase in intensity of the blue colour in the hydrogel (not visible in FIG. 6H) indicates that it was dehydrated and rather saturated with copper ions.

### 4. Conclusions

The Zn and Cu electrodes in contact with the respective hydrogels exhibit reversible reactions, demonstrating that the hydrogel battery is rechargeable. In addition, a very low Cu content at the Zn electrode and hydrogel surface after 100 charge-discharge cycles confirms the coordination of the Cu in the hydrogel. In addition, the results confirm the mechanism of Na⁺ shuttling between the electrode compartments to maintain charge neutrality in both of the battery designs. The interplay of both mechanisms allows for the realization of a rechargeable Zn—Cu battery without a separator.

It is expected that use of porous and nano-structured electrode materials rather than metal foils will result in improved performance of such hydrogel batteries. The composition of the hydrogel can be further optimized to enhance the uptake of Cu ions. Additionally, it is expected that reducing the thickness of the hydrogels and improving water retention capacity of the Cu hydrogel will improve the capacity retention. Finally, further significant performance improvements can be made by minimizing the contact resistances between the different layers of the hydrogel battery.

### EQUIVALENTS

While the invention has been described with respect to illustrative embodiments thereof, it will be understood that various changes may be made to the embodiments without departing from the scope of the invention. Accordingly, the described embodiments are to be considered merely exemplary and the invention is not to be limited thereby.

### REFERENCES

Boulabiar A., K. Bouraoui, M. Chastrette, M. Abderrabba, A historical analysis of the Daniell cell and electrochemistry teaching in French and tunisian textbooks, Journal of Chemical Education 81 (5) (2004) 754.

Chen D., M. A. Hickner, E. Agar, E. C. Kumbur, Selective anion exchange membranes for high coulombic efficiency vanadium redox flow batteries, Electrochemistry Communications 26 (2013) 37-40.

Clark S., A. R. Mainar, E. Iruin, L. C. Colmenares, J. A. Bl'azquez, J. R. Tolchard, A. Latz, B. Horstmann, Towards rechargeable zinc-air batteries with aqueous chloride electrolytes, Journal of Materials Chemistry A 7 (18) (2019) 11387-11399.

Dong X., Y. Wang, Y. Xia, Re-building Daniell cell with a Li-ion exchange film, Scientific reports 4 (2014) 6916.

Fang G., J. Zhou, A. Pan, S. Liang, Recent advances in aqueous zinc ion batteries, ACS Energy Letters 3 (10) (2018) 2480-2501.

Jameson A., A. Khazaeli, D. P. Barz, A rechargeable zinc copper battery using a selective cation exchange membrane, Journal of Power Sources 453 (2020) 227873.

Lee S. H., K. Kim, C.-W. Yi, Poly (acrylamide-co-acrylic acid) gel electrolytes for Ni—Zn secondary batteries, Bulletin of the Korean Chemical Society 34 (3) (2013) 717-718.

Lim H., A. Lackner, R. Knechtli, Zinc-bromine secondary battery, Journal of the Electrochemical Society 124 (8) (1977) 1154-1157.

Liu Q., Y. Wang, L. Dai, J. Yao, Scalable fabrication of nanoporous carbon fiber films as bifunctional catalytic electrodes for flexible Zn air batteries, Advanced Materials 28 (15) (2016) 3000-3006.

Pan H., Y. Shao, P. Yan, Y. Cheng, K. S. Han, Z. Nie, C. Wang, J. Yang, X. Li, P. Bhattacharya, et al., Reversible aqueous zinc/manganese oxide energy storage from conversion reactions, Nature Energy 1 (5) (2016) 1-7.

Parikipandla B., A. Helwig, T. Bryne, G. Holmes, T. Ahfock, Daniell cell investigation for energy storage, in: 2017 Australasian Universities Power Engineering Conference (AUPEC), IEEE, 2017, pp. 1-4.

Parker J. F., C. N. Chervin, I. R. Pala, M. Machler, M. F. Burz, J. W. Long, D. R. Rolison, Rechargeable nickel-3D zinc batteries: An energy-dense, safer alternative to lithium-ion, Science 356 (6336) (2017) 415-418.

Parker J. F., I. R. Pala, C. N. Chervin, J. W. Long, D. R. Rolison, Minimizing shape change at Zn sponge anodes in rechargeable Ni—Zn cells: impact of electrolyte formulation, Journal of The Electrochemical Society 163 (3) (2016) A351-A355.

Selvakumaran D., A. Pan, S. Liang, G. Cao, A review on recent developments and challenges of cathode materials for rechargeable aqueous Zn-ion batteries, Journal of Materials Chemistry A 7 (31) (2019) 18209-18236.

Song M., H. Tan, D. Chao, H. J. Fan, Recent advances in Zn-ion batteries, Advanced Functional Materials 28 (41) (2018) 1802564.

Wang Z., F. Mo, L. Ma, Q. Yang, G. Liang, Z. Liu, H. Li, N. Li, H. Zhang, C. Zhi, Highly compressible cross-linked polyacrylamide hydrogel enabled compressible Zn—MnO2 battery and a flexible battery-sensor system, ACS applied materials & interfaces 10 (51) (2018) 44527-44534.

Zeng Y., X. Zhang, Y. Meng, M. Yu, J. Yi, Y. Wu, X. Lu, Y. Tong, Achieving ultrahigh energy density and long durability in a flexible rechargeable quasi-solid-state zn—mno2 battery, Advanced Materials 29 (26) (2017) 1700274.

Zhang H., T. Yang, X. Wu, Y. Zhou, C. Yang, T. Zhu, R. Dong, Using Li+ as the electrochemical messenger to fabricate an aqueous rechargeable Zn—Cu battery, Chemical Communications 51 (34) (2015) 7294-7297.

Zhang N., F. Cheng, J. Liu, L. Wang, X. Long, X. Liu, F. Li, J. Chen, Rechargeable aqueous zinc-manganese dioxide batteries with high energy and power densities, Nature communications 8 (1) (2017) 1-9.

Zhu Q., M. Cheng, B. Zhang, K. Jin, S. Chen, Z. Ren, Y. Yu, Realizing a rechargeable high-performance Cu—Zn battery by adjusting the solubility of Cu²⁺, Advanced Functional Materials 29 (50) (2019) 1905979.

1. A hydrogel battery, comprising:
a first compartment comprising a first electrode metal and a first hydrogel;
a second compartment comprising a second electrode metal and a second hydrogel;
a background electrolyte (BGE) metal ion species;
wherein at least one of the first hydrogel and the second hydrogel selectively coordinates ions of at least one of the first and second electrode metals;
wherein the first hydrogel and the second hydrogel allow the BGE metal ion species to travel between the first and second compartments.

2. The hydrogel battery of claim 1, wherein only the first hydrogel selectively coordinates metal ions.

3. The hydrogel battery of claim 1, wherein the first electrode metal that is coordinated in the first hydrogel is selected from copper, cadmium, chromium, iron, manganese, nickel, zinc, cerium, and silver.

4. The hydrogel battery of claim 1, wherein the second electrode metal that is coordinated in the second hydrogel is different from the first electrode metal and is selected from copper, cadmium, chromium, iron, manganese, nickel, zinc, cerium, and silver.

5. The hydrogel battery of claim 2, wherein the second electrode metal that is not coordinated in the second hydrogel is different from the first electrode metal and is selected from copper, cadmium, chromium, iron, manganese, nickel, zinc, cerium, silver, lead, and cobalt.

6. The hydrogel battery of claim 1, wherein the first electrode metal comprises copper and the second electrode metal comprises zinc.

7. The hydrogel battery of claim 1, wherein the BGE metal ion species is at least one of sodium (Na⁺) and potassium (K⁺).

8. The hydrogel battery of claim 1, wherein the BGE metal ion species is sodium (Na⁺).

9. The hydrogel battery of claim 1, wherein the first compartment and the second compartment are in contact with each other without a separator disposed between them.

10. The hydrogel battery of claim 1, wherein the hydrogel battery is rechargeable.

11. The hydrogel battery of claim 1, wherein the hydrogel battery is flexible.

12. A method for preparing a hydrogel battery, comprising:
providing a first compartment comprising a first electrode metal and a first hydrogel;
providing a second compartment comprising a second electrode metal and a second hydrogel;
providing a background electrolyte (BGE) metal ion species;
wherein at least one of the first hydrogel and the second hydrogel selectively coordinates ions of at least one of the first and second electrode metals;
wherein the first hydrogel and the second hydrogel allow the BGE metal ion species to travel between the first and second compartments.

13. The method of claim 12, wherein only the first hydrogel selectively coordinates metal ions.

14. The method of claim 12, wherein the first electrode metal that is coordinated in the first hydrogel is selected from copper, cadmium, chromium, iron, manganese, nickel, zinc, cerium, and silver.

15. The method of claim 12, wherein the second electrode metal that is coordinated in the second hydrogel is different from the first electrode metal and is selected from copper, cadmium, chromium, iron, manganese, nickel, zinc, cerium, and silver.

16. The method of claim 13, wherein the second electrode metal that is not coordinated in the second hydrogel is different from the first electrode metal and is selected from copper, cadmium, chromium, iron, manganese, nickel, zinc, cerium, silver, lead, and cobalt.

17. The method of claim 12, wherein the first electrode metal comprises copper and the second electrode metal comprises zinc.

18. The method of claim 12, wherein the BGE metal ion species is at least one of sodium (Na⁺) and potassium (K⁺).

19. The method of claim 12, wherein the BGE metal ion species is sodium (Na⁺).

20. The method of claim 12, wherein the first compartment and the second compartment are in contact with each other without a separator disposed between them.

21. The method of claim 12, wherein the hydrogel battery is rechargeable.

22. The method of claim 12, wherein the hydrogel battery is flexible.
